(19) United States
(12) Patent Application Publication
(10) Pub. No.: US 2015/0375655 A1
(43) Pub. Date: Dec. 31, 2015

(54) BACKREST FRAME FOR A SEAT, IN PARTICULAR FOR A VEHICLE SEAT, AND VEHICLE SEAT

(71) Applicant: JOHNSON CONTROLS COMPONENTS GMBH & CO. KG, Kaiserslautern (DE)

(72) Inventors: Wolfgang PLUTA, Heiligenmoschel (DE); Thomas DILL, Heiligenmoschel (DE); Heinrich HAMMANN, Teschenmoschel (DE); Viktor ENNS, Kaiserslautern (DE); Christian WOLF, Katzenbach (DE)

(73) Assignee: JOHNSON CONTROLS COMPONENTS GMBH & CO. KG, Kaiserslautern (DE)

(21) Appl. No.: 14/770,617

(22) PCT Filed: Jan. 7, 2014
(86) PCT No.: PCT/EP2014/050147

§ 371 Date: Aug. 26, 2015

(30) Foreign Application Priority Data
Feb. 27, 2013 (DE) 10 2013 203 292.7
Sep. 10, 2013 (DE) 10 2013 218 096.9

(51) Int. Cl. B60N 2/68; B60N 2/64

(52) U.S. Cl. CPC B60N 2/686; B60N 2/64

(57) ABSTRACT

A backrest frame (2) for a seat, in particular a vehicle seat, includes a number of frame parts (2.1 to 2.4), which can be fixedly connected to a rear plate (1). At least one first frame part (2.1) is configured as an at least sectionally closed or semi-open hollow profile. At least one of the ends of the hollow profile is recessed in some regions.

### CROSS REFERENCE TO RELATED APPLICATIONS

This application is a United States National Phase Application of International Application PCT/EP2014/050147 filed Jan. 7, 2014 and claims the benefit of priority under 35 U.S.C. §119 of German Patent Applications 10 2013 203 292.7 filed Feb. 27, 2013 and 10 2013 218 096.9 filed Sep. 10, 2013 the entire contents of which are incorporated herein by reference.

### FIELD OF THE INVENTION

The invention relates to a backrest frame for a seat, in particular for a vehicle seat, wherein the backrest frame comprises a number of frame parts which are able to be fixedly connected to a rear plate. The invention further relates to a backrest comprising such a backrest frame.

### BACKGROUND OF THE INVENTION

The backrest of a seat, in particular of a vehicle seat, generally comprises a rear plate and a plurality of frame parts for the support which form a backrest frame, said frame parts being fixedly connected to the rear plate. In this case, the frame parts have a substantially U-shaped cross section and/or are designed as a closed hollow profile.

### SUMMARY OF THE INVENTION

It is an object of the present invention to specify a backrest frame for a seat which may be fastened in a simple and secure manner to the rear plate as well as a backrest comprising such a backrest frame.

A backrest frame for a seat comprises a number of frame parts which are able to be fixedly connected to a rear plate, wherein according to the invention it is provided that at least one first frame part is at least partially configured as a semi-open or closed hollow profile, wherein at least one of the ends of the hollow profile is at least partially recessed.

Since the end of the hollow profile is at least partially recessed, a free space is formed for producing a non-positive, positive and/or material connection in order to fasten the hollow profile to a further component.

Such a frame part which is configured as an at least partially closed or semi-open hollow profile with ends which are cut to length in an oblique and/or curved manner and/or notched, as a partial recess, is able to be easily produced and permits the frame part to be able to be arranged in a simple manner on a further component, in particular on a rear plate of the seat by a positive, non-positive and/or material connection and, in particular, to be weldable to this further component.

The invention relates in this case both to the backrest frame itself and to a backrest for a seat with the backrest frame and a rear plate which is connected at least by a material connection to the backrest frame.

In one embodiment, the at least one end of the at least one first frame part is cut to length at a predetermined angle in an oblique and/or curved manner and/or notched, whereby a free space is formed as an aid for fastening lateral frame parts to the first frame part. In other words, a region which is easily accessible by the oblique portions, by a rounded portion and/or by the notched portion is formed for a laser which is able to be guided, in particular articulated, onto a surface to be welded.

In one possible embodiment, the at least one frame part forms a lower crossmember of the backrest frame and lateral frame parts are at least fastenable by a material connection to the first frame part. The first frame part as a crossmember advantageously serves, in particular, as a receiver element for fastening the two lateral frame parts and for absorbing forces, wherein the backrest frame is advantageously stabilized by means of the first frame part as a crossmember.

In this case, the first frame part as a partially semi-open or closed hollow profile may also be an upper crossmember or a lateral member or a further component configured as a hollow profile which is weldable as a frame part.

In a further possible embodiment, the rear plate is able to be connected at least by a material connection to the frame parts. As a result, the rear plate and the frame parts are connected fixedly together, wherein this connection is not releasable without being substantially destroyed. Furthermore, advantageously no additional constructional space is required for arranging fastening means, such as for example screws and/or screw nuts.

In one embodiment, at least one second frame part is configured as a U-shaped profile and forms an upper crossmember of the backrest frame, the stability of the backrest frame advantageously being further increased thereby at least in the horizontal direction.

In a further embodiment, the frame parts are formed from sheet steel, so that the frame parts, on the one hand, have a relatively low weight and, on the other hand, the desired properties are adjustable by means of the alloy. Preferably, the frame parts are configured to be relatively robust and suitable for welding thereto and/or to a further material.

The invention is described in more detail with reference to exemplary embodiments and with reference to the accompanying schematic figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic exploded view showing a rear plate with the mounted backrest frame and unmounted fittings;

FIG. 2 is a schematic exploded view showing a rear plate and a plurality of frame parts of a backrest frame;

FIG. 3 is a schematic perspective view a rear plate with the mounted backrest frame which comprises at least one frame part which is configured as a closed hollow profile and which is cut to length at the ends in an oblique manner;

FIG. 4 is a schematic enlarged perspective view showing a rear plate in the region of an end cut to length in an oblique manner of a closed hollow profile;

FIG. 5 is a schematic enlarged perspective view showing the rear plate in the region of the end cut to length in an oblique manner of a closed hollow profile;

FIG. 6 is a schematic plan view showing a rear plate with frame parts welded thereto;

FIG. 7 is a schematic perspective view showing two frame parts fastened to one another, wherein one frame part is notched; and

FIG. 8 is a schematic perspective view showing two frame parts fastened to one another, wherein one frame part is cut to length in a curved manner.

### DESCRIPTION OF THE PREFERRED EMBODIMENTS

Parts which correspond to one another are provided in all of the figures with the same reference numerals.

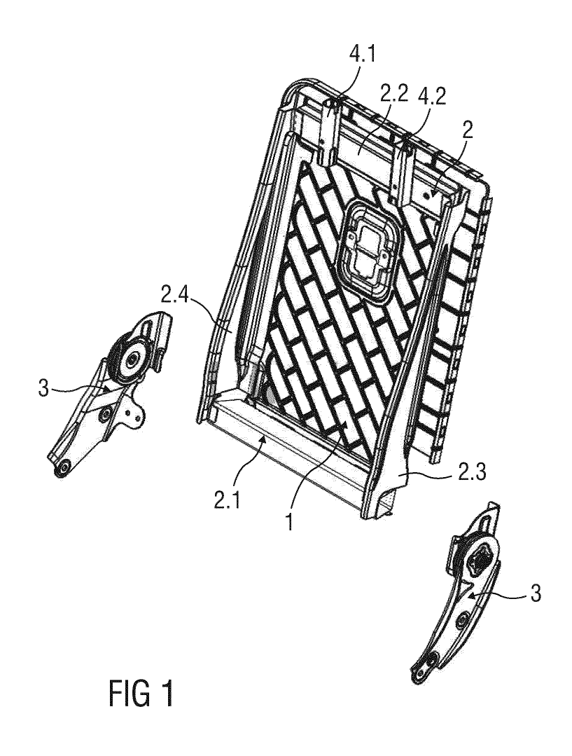

FIG. 1 shows schematically in an exploded view a rear plate 1 with the mounted backrest frame 2 and unmounted fittings 3. The backrest frame 2 is formed from a plurality of frame parts 2.1 to 2.4.

The rear plate 1 with the backrest frame 2 is part of a seat, not shown in more detail, in particular a vehicle seat or a rear seat arrangement of a motor vehicle. The backrest frame 2 and the rear plate 1 form the supporting element of the seat. The fastening of the backrest frame 2 to the rear plate 1 may take place in the conventional manner by means of screws, rivets and/or welding. Preferably, the components are connected together by means of welding.

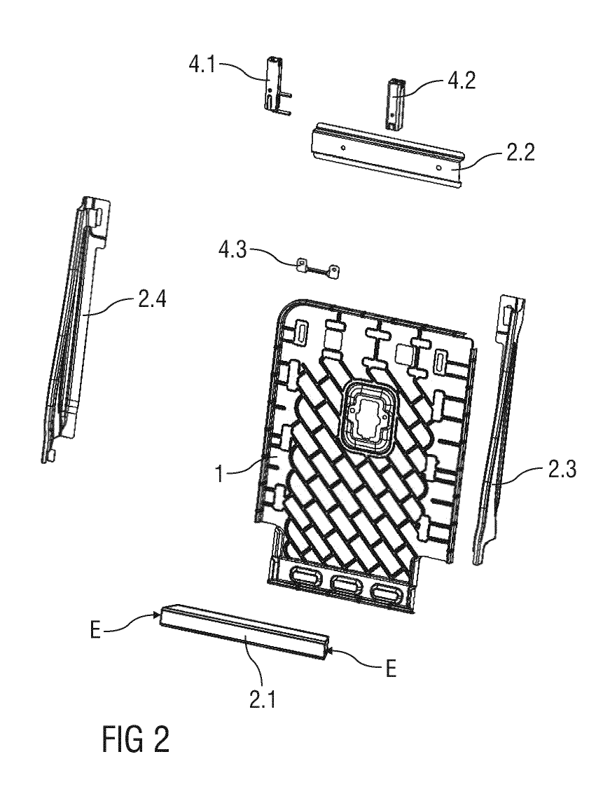

FIG. 2 shows schematically the rear plate 1 and the backrest frame 2 formed from the frame parts 2.1 to 2.4, in an exploded view. In this case, a first frame part 2.1 is designed as a closed hollow profile, the ends E thereof being cut to length in an oblique manner. The first frame part 2.1 forms a lower crossmember. A second frame part 2.2 is provided opposite said first frame part, said second frame part being configured as a U-shaped profile and forming an upper crossmember.

Moreover, the backrest frame 2 comprises as vertical frame struts two lateral parts which are denoted as the third frame part 2.3 and the fourth frame part 2.4 and oppose one another.

According to the arrangement of a seat backrest formed from the rear plate 1 and the backrest frame 2, the first frame part 2.1 is denoted as the lower crossmember, the second frame part 2.2 as the upper crossmember and the frame parts 2.3 and 2.4 as the vertical lateral parts. The frame parts 2.1 to 2.4 are applied from the front onto the rear plate 1 and fastened there, as shown with reference to FIG. 1, in which the frame parts 2.1 to 2.4 are shown fastened from the front onto the rear plate 1.

The frame parts 2.1 to 2.4 are conventionally formed from sheet metal, in particular sheet steel.

Additionally, further components 4.1 to 4.3 may be provided. Thus, for example, the components 4.1 to 4.2 form receivers for heat restraint retaining rods. Depending on the type and function of the further components 4.1 to 4.3, said components may serve for reinforcing, retaining and receiving further seat parts, such as the side airbag, head restraints, seat heating and/or upholstery.

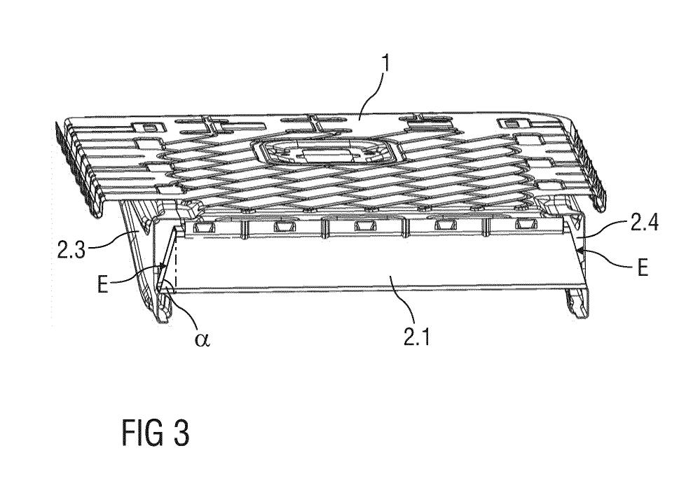

FIG. 3 shows schematically the rear plate 1 with the mounted backrest frame 2 in a plan view of the lower crossmember and thus the first frame part 2.1. The frame part 2.1 is configured as a closed hollow profile, in particular as a rectangular hollow profile and cut to length in an oblique manner at the ends. The frame part 2.1 in each case is cut to length in an oblique manner at the ends E thereof at a predetermined angle α, such that a laser, not shown in more detail, is able to be guided, in particular articulated, into a freely accessible region B formed by the oblique portions and thus into a surface to be welded.

In the exemplary embodiment shown, the oblique portions at the ends toward the front, i.e. away from the rear plate 1 toward the front, are designed to be widened, so that the surfaces of the hollow profile which bear against the lateral parts, and thus the frame parts 2.3 and 2.4, are at least partially freely accessible for a laser, not shown. Thus the first frame part 2.1 together with the lateral frame parts 2.3 and 2.4 may be welded in a simple manner by means of laser welding to form a closed, or at least partially closed, backrest frame 2.

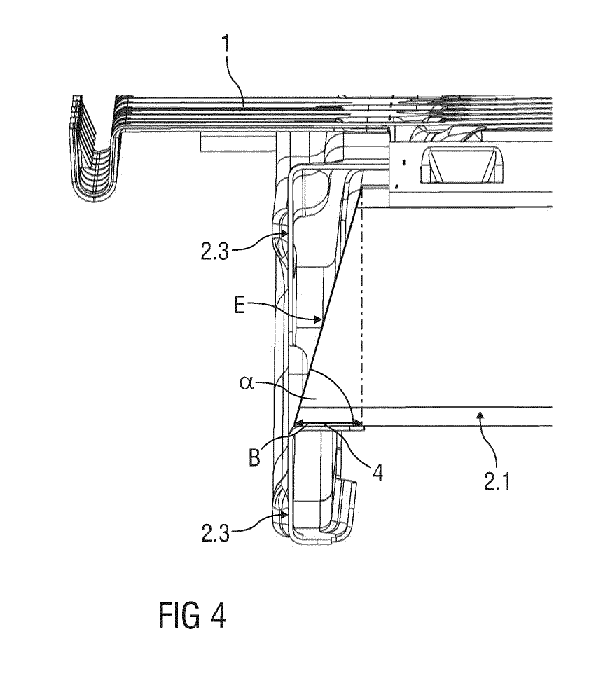

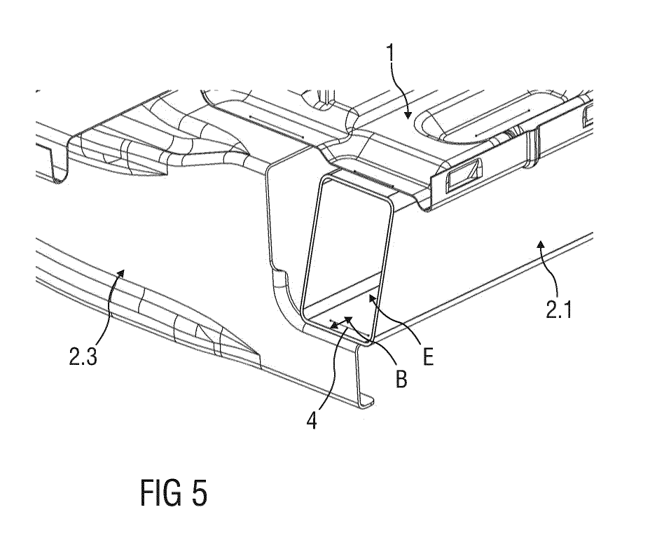

FIGS. 4 and 5 show schematically in an enlarged perspective view the rear plate 1 and the backrest frame 2 in the region of one of the ends E, cut to length in an oblique manner, of the frame part 2.1 which is configured as a closed hollow profile. In the freely accessible region B formed by the oblique portions of the ends E and thus formed therein, the frame part 2.1 is welded to the lateral frame part 2.3 by means of a welded seam 4.

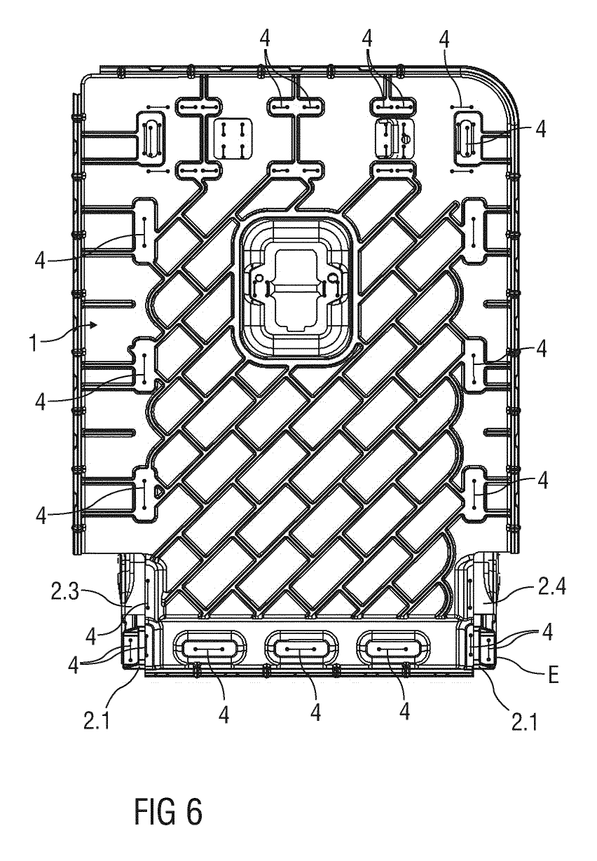

FIG. 6 shows schematically in a plan view from the rear the rear plate 1 with frame parts 2.1 to 2.4 welded thereto by means of a plurality of welded seams 4.

In this case, both the frame parts 2.1 to 2.4 are welded by means of a plurality of welded seams 4 to form a closed backrest frame 2, which in turn is welded to the rear plate 1 by means of further welded seams 4.

For the material connection of the parts to one another, said parts may be arranged and prefixed relative to one another in a previous mounting step, in particular inserted into or latched with one another. Alternatively, the parts may be successively connected together in a predetermined sequence.

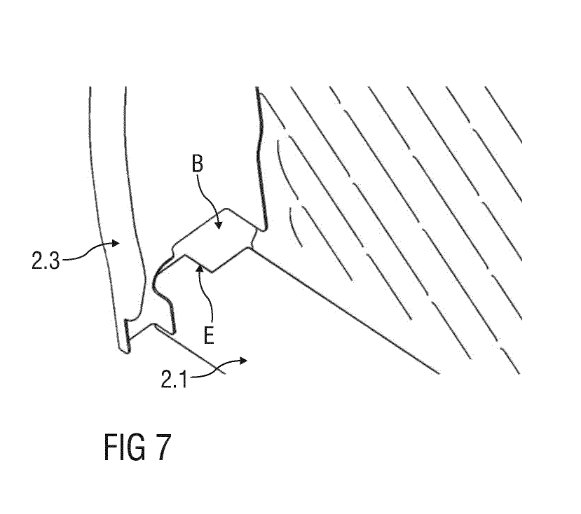

FIG. 7 shows a perspective view of two frame parts 2.1, 2.3 fastened to one another, wherein the first frame part 2.1 is notched at the end E facing the lateral third frame part 2.3. A freely accessible region B is produced by means of the notched region for producing a connection between the two frame parts 2.1, 2.3.

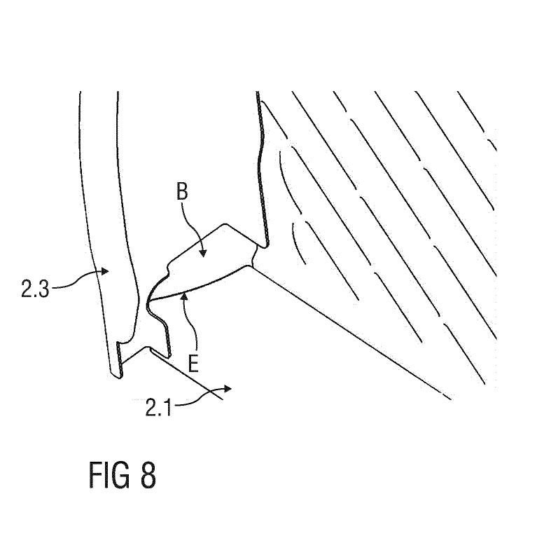

A perspective view of the two frame parts 2.1, 2.3 fastened to one another is shown in FIG. 8. In this case, the end E of the first frame part 2.1 fastened to the lateral third frame part 2.3 is of concave configuration and accordingly has a curved shape. Also in this case, a freely accessible region B, in particular for a laser, is formed by means of the concave configuration of the end of the first frame part 2.1.

While specific embodiments of the invention have been shown and described in detail to illustrate the application of the principles of the invention, it will be understood that the invention may be embodied otherwise without departing from such principles.

1. A backrest frame for a seat, the backrest frame comprising:
a number of frame parts which are able to be fixedly connected to a rear plate, wherein at least one first frame part is at least partially configured as a semi-open or closed hollow profile, wherein at least one of the ends of the hollow profile is at least partially recessed.

2. The backrest frame as claimed in claim 1, wherein the at least one end is recessed such that the end has at least one of an oblique portion, at least one rounded portion and a notched portion.

3. The backrest frame as claimed in claim 1, wherein the at least one end is recessed such that a free space for an aid for fastening a component to the first frame part, as a freely accessible region, is formed for a laser which is able to be guided, and articulated, onto a surface to be welded.

4. The backrest frame as claimed in claim 1, wherein the at least one end of the at least one first frame part is cut to length at a predetermined angle in an oblique manner.

5. The backrest frame as claimed in claim 1, wherein the at least one first frame part forms a lower crossmember of the backrest frame and lateral frame parts are fastened at least by a material connection to the first frame part.

6. The backrest frame as claimed in claim 1, wherein the rear plate is able to be connected at least by a material connection to the frame parts.

7. The backrest frame as claimed in claim 1, wherein at least one second frame part is configured as a U-shaped profile and forms an upper crossmember of the backrest frame.

8. The backrest frame as claimed in claim 1, wherein the frame parts are formed from sheet steel.

9. A backrest for a vehicle seat, the backrest comprising:
a rear plate;
a backrest frame comprising a plurality of frame parts which are able to be fixedly connected to a rear plate, wherein at least one first frame part is at least partially configured as a semi-open or closed hollow profile, wherein at least one of the ends of the hollow profile is at least partially recessed and, wherein the backrest frame is connected at least by a material connection to the rear plate.

10. The backrest as claimed in claim 9, wherein the at least one end is recessed such that the end has at least one of an oblique portion, at least one rounded portion and a notched portion.

11. The backrest as claimed in claim 9, wherein the at least one end is recessed such that a free space for an aid for fastening a component to the first frame part, as a freely accessible region, is formed for a laser which is able to be guided, and articulated, onto a surface to be welded.

12. The backrest as claimed in claim 9, wherein the at least one end of the at least one first frame part is cut to length at a predetermined angle in an oblique manner.

13. The backrest frame as claimed in claim 9, wherein the at least one first frame part forms a lower crossmember of the backrest frame and lateral frame parts are fastened at least by a material connection to the first frame part.

14. The backrest frame as claimed in claim 9, wherein the rear plate is able to be connected at least by a material connection to the frame parts.

15. The backrest frame as claimed in claim 9, wherein at least one second frame part is configured as a U-shaped profile and forms an upper crossmember of the backrest frame.

16. The backrest frame as claimed in claim 9, wherein the frame parts are formed from sheet steel.

17. A vehicle seat backrest comprising:
a rear plate;
a backrest frame comprising:
a lower crossmember;
an upper crossmember;
a first side lateral frame part;
a second side lateral frame part, wherein at least one of the lower crossmember, the upper crossmember, the first side lateral frame part and the second side lateral frame part has a hollow profile with a hollow profile end that is at least partially recessed; and
a material connection connecting the backrest frame to the rear plate.

18. The backrest as claimed in claim 17, wherein the recessed hollow profile end comprises at least one of an oblique portion, a rounded portion and a notched portion.

19. The backrest as claimed in claim 18, wherein:
the lower crossmember, the upper crossmember, the first side lateral frame part and the second side lateral frame part are formed from sheet steel;
the lower crossmember has the hollow profile;
the lower crossmember and lateral frame parts are fastened at least by a material connection;
the recessed hollow profile end defines a free space access to a surface to be welded; and
the rear plate is connected a material connection to the backrest frame.

20. The backrest frame as claimed in claim 19, wherein the upper crossmember has a U-shaped profile.
